(19) United States
(12) Patent Application Publication
(10) Pub. No.: US 2026/0254917 A1
(43) Pub. Date: Aug. 27, 2026

(54) SYSTEM AND METHOD FOR DYNAMIC TIME-LAPSE VIDEO RECORDING

(71) Applicant: Wyze Labs, Inc., Kirkland, WA (US)

(72) Inventors: Tao Yuan, Redmond, WA (US); Larry Jing, Bellevue, WA (US)

(73) Assignee: Wyze Labs, Inc., Kirkland, WA (US)

(21) Appl. No.: 19/649,768

(22) Filed: Apr. 16, 2026

Related U.S. Application Data
(63) Continuation of application No. PCT/US2025/011528, filed on Jan. 14, 2025.
(60) Provisional application No. 63/623,372, filed on Jan. 22, 2024.

(51) Int. Cl. H04N 5/91; G06V 10/764; G06V 10/94; G06V 20/40; G06V 40/10; H04N 7/01; H04N 23/611

(52) U.S. Cl. CPC H04N 5/91; G06V 10/764; G06V 20/44; H04N 7/0127; H04N 23/611; G06V 10/945; G06V 40/10; G06V 2201/08

(57) ABSTRACT

A system and method for recording and/or displaying video using dynamic frame rates based on the content of the video. The method includes automatically adjusting the frame rate according to specific criteria that may include different types of events such as movement events, a person event, a vehicle event, and the like. The criteria are optionally implemented in control logic that may include neural networks or other Artificial Intelligence (AI) operable to automatically determine an event has occurred, and/or the type of the event. Portions of the disclosed control logic may be included in a camera capturing the video data, and/or portions of it may be located on a remote cloud service, or any combination thereof.

### CROSS-REFERENCE TO RELATED APPLICATION

This application is a continuation of International Patent Application No. PCT/US2025/011528, filed Jan. 14, 2025, which claims the benefit of U.S. Provisional Application No. 63/623,372 filed Jan. 22, 2024, which is hereby incorporated by reference to the extent not inconsistent.

### BACKGROUND

A time-lapse recording is generally a video recording where a sequence of image frames is captured at a slower rate and then played back later at a faster rate. This causes events in the video to appear to move more quickly in time. In the case of a camera capturing the video, cameras provide time-lapse functionality to compress a long duration video into a much shorter video. For example, if 1 image is recorded every 10 seconds, and the resulting video is played back at 30 frames per second (fps), a 24-hour recording period may be shortened to about a 5 minute playback period.

In general, the interval between each two consecutive frames in a time-lapse recording is constant so that the video will be played at constant speed throughout the entire playback. This standard approach for a time-lapse video works well in some instances, such as when recording a sunrise or a sunset, a flower blooming, or an all-day event like a party or a home project. These kinds of events may last for hours or days and the events of interest that are taking place may be generally evenly distributed during most, if not all, of the recording period. Thus it is useful to capture what is happening at a steady frame rate because no part of the recording is more or less interesting than any other part.

However, in the case of cameras located in a fixed location watching, for example, a room, parking lot, front porch, garage entrance, or warehouse, the cameras are placed in a fixed location to monitor a specific field of view. Interesting events, such as a person, vehicle, pet, or other object, moving through the camera's field of view may be relatively rare. Thus the interesting portions of the video may be a very small percentage of what is captured. Most of the interesting events may only last for a few seconds or minutes, and the next interesting event may not occur until minutes or hours later.

### SUMMARY

Disclosed is a system and method for generating a time-lapse video which has dynamically changing time intervals between frames. The changing intervals may be adjusted during the recording process based on event information gleaned from the video. This allows cameras to capture events of interest at a frame rate that is different (generally higher) than is used for periods of the recording where nothing of interest is happening. During these “idle” periods in the recording, the frame rate may be kept much lower. Depending on whether an event is detected, and depending on the event type, the system of the present disclosure optionally automatically determines whether to increase or decrease the current frame rate.

For example, the system is optionally configured to record more details for person or pet events, such as by changing the frame rate to record at 5 frames per second. In the case of other types of events, or in the case where no event of interest is taking place, the system may change the frame rate to record at 1 frame per minute (a 300 fold reduction in recorded frames).

In another aspect, the system may be configured to record at different frame rates for different types of categories of events. For example, the system may be configured to set the frame rate to 10 frames per second for an event that includes unfamiliar people, and to adjust the frame rate to 5 frames per second if an event includes familiar people, or to adjust the frame rate to 1 frame per minute if no events of interest are occurring.

In another aspect, the resulting video experience may be improved if the present frame rate is gradually adjusted to match a new frame rate determined by the system. This gradual ramping up or down advantageously allows for slower changes in the recording rate which translates into a video gradually increasing playback speed after an event as the system determines that no events of interest are taking place.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a component diagram illustrating components that may be included in a system of the present disclosure.

FIG. 2 is a flowchart illustrating aspects of the disclosed method for dynamic time-lapse video recording.

FIG. 3 is a flowchart illustrating one example of additional actions that may be taken in performing the method of the present disclosure.

### DETAILED DESCRIPTION

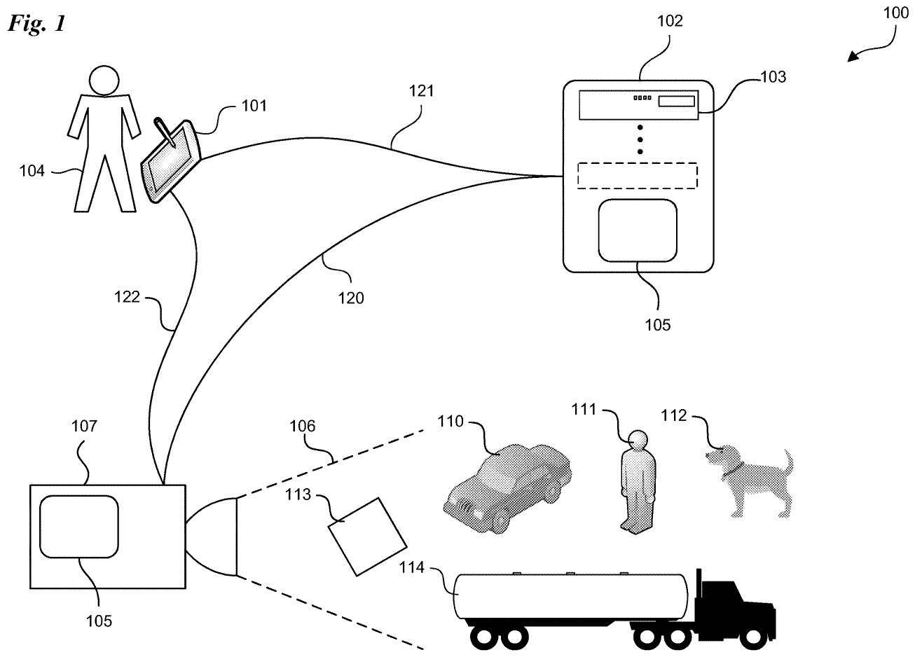

Illustrated in FIG. 1 at 100 is one example of components that may be included in a system of the present disclosure. The system may include a camera 107 (or multiple cameras) operable to capture images within a field-of-view, viewing area, detection region, or detection zone 106 defined by the camera 107.

The camera 107 may include control logic 105 which may implement some or all of the logical operations, algorithms, or other aspects of the disclosed method. The control logic may be useful for operation of the camera to capture video imagery at varying frame rates according to the present disclosure. Control logic 105 may include, or be electrically connected to, a processor, memory, or other logic circuitry, and/or sensors such as Charged Couple Devices (CCDs) or Complimentary Metal Oxide Semiconductor (CMOS) image sensors, which may be used to capture since parameters including sound, motion, and/or light, which may be visible or invisible to the human eye.

Control logic 105 may also include configuration settings and logical processes which may be used by the disclosed system to determine what type of object is within the field-of-view 106. Some exemplary types of objects that may be detected and categorized by the control logic of the present disclosure are illustrated in FIG. 1. These include, but are not limited to, vehicles such as a car 110, a truck 114, people 111, animals 112, or other objects 113.

The control logic may include one or more rules with criteria or thresholds for determining that objects are present, or that activities are occurring, within the field of view of the camera (and by extension, in the frames of video the camera captures) that may be of particular interest. For example, when the control logic is applied to incoming frames of video captured by camera 107, the algorithms of the present disclosure may indicate movement has occurred within the camera's field-of-view 106. In another aspect, the control logic may be operable to determine a category or type for an object that is present in the field of view 106. This may be useful for determining that a delivery truck has arrived, that a person is at the door, and optionally whether the person or truck is familiar or unfamiliar.

In another aspect, Artificial Intelligence (AI) algorithms or decision-making models may be included in the control logic 105 of the present disclosure and may be configured to determine that an object passed through the field-of-view 106 of the camera. The optional artificial intelligence models that may be implemented in control logic 105 may also be configured to determine what type of object is present. These AI models or algorithms may be operable to classify the type of object automatically preferably without human intervention. The AI algorithms may, for example, include one or more neural networks, such as a Convolutional Neural Network (CNN), or other similar decision making algorithm. Transformers optimized for decision making using captured video feeds as input may also be implemented in control logic 105 in place of, or along with other algorithms or models.

In another aspect the control logic may be configured to maintain a collection of familiar objects, unfamiliar objects, or any combination thereof. This data may be updated automatically over time as the decision-making paradigm of the control logic 105, and any optional AI algorithms that may be included therein, is improved with additional input and training.

In one example, an algorithm configured to make comparisons using rules, thresholds, or other criteria maintained by the control logic 105, may be used to determine when image data captured by the camera changes over time. These changes may be analyzed by the algorithm in real time, or later after the video has been saved and retrieved for analysis, to determine when changes occurring within the field-of-view 106 match the criteria in the algorithm which are configured to indicate that movement has occurred. Predetermined values may be assigned on a gradient with predefined maximum and minimum values. In one example, no change may be defined as a value of 0.0, while a high degree of change may be assigned a maximum value of 1.0. Threshold values may then be assigned on a gradient between these extremes to specify when enough change has occurred to indicate movement.

In another aspect, the camera 107 may capture multiple individual frames over time such as at the rate of 30 frames per second, or 60 frames per second, or any other suitable rate. The control logic 105 of the camera may be configured to present the individual frames captured by the camera as input to the algorithm to determine if movement has occurred, and optionally to determine a category for the events taking place, or for the objects involved in those events. The algorithm may, for example, compare the pixels at or near corresponding positions of the individual frames for one or more successive frames to determine if the pixel data has changed according to the criteria in the rules. These individual pixel “deltas” may be grouped together, filtered, and/or compared over time to determine whether the changes in the pixel data are sufficient to trigger an alert that movement has been detected, that an object is present, and the like. They may also be used to determine a category for the activity that has occurred. In another aspect, the changes in pixel data may be compared and may be the basis for determining changes in lighting, shadows, positions of objects, types of objects, familiarity, and the like. The results of these comparisons performed according to the disclosed method may be further input for the control logic as it determines whether shapes and configurations of objects in relation to one another indicate an event has taken place, and/or whether this event includes familiar faces, objects, vehicles, and the like. The overall result of these comparisons may be assigned values according to the predetermined gradients between a maximum and minimum value. The control logic may be configured to trigger a change to a different recording frame rate if one or more of the comparison outcomes are outside of predefined triggering ranges or thresholds specified in the control logic.

For example, a camera positioned outside a warehouse may be mounted at a corner of the building with a field of view that includes a parking area adjacent to the warehouse. This area within the field-of-view of the camera may change very little over time except when a vehicle, person, or other object happens to pass through the area, or stops within the camera's detection region. As a vehicle enters the field-of-view, the pixel data within the frames captured by the camera shifts from the normal black or gray colors of the parking area with its grid of painted lines to accommodate the color and shape of the vehicle. A small change of a few pixels may be insufficient to trigger a frame rate adjustment, but a growing number of pixels changing rapidly within a few frames, or an overall increase in the number of pixels that have changed may be sufficient to trigger a movement event, or to trigger an event indicating that an object is now in view, or that some other type of event is taking place. The changing pixel data may also be used to determine what type of object is moving into the field of view according to the shape, color, markings, lights, type of activity, or other characteristics perceived by the control logic.

The control logic may include criteria for determining not only that motion is occurring in the video data, but that a particular type of activity is taking place, or that a particular type of object is within the field-of-view of the camera. Control logic 105 may be configured with pattern recognition algorithms operable to detect packages, faces, animals, vehicles, and the like. These pattern recognition algorithms may include multiple predetermined matching criteria specific to individual portions of the image, or to the image overall, or to specific configurations of shapes or arrangements of shadows, or other image features. Any suitable method for determining the type of objects within the field-of-view of the camera may be used by the control logic criteria for categorizing objects appearing, disappearing, or otherwise moving within the field-of-view 106.

In another aspect, pattern recognition algorithms may include criteria specific to determine whether an object appearing in the image is familiar or unfamiliar. The criteria may be trained to automatically detect familiar persons, vehicles, animals, and the like based on past experience and/or input from a user. For example, the system may determine that a vehicle is a delivery truck from a well-known delivery service. In another example, the system may determine at first that a delivery vehicle is present, but that it is unfamiliar to the system. This scenario might occur when a new delivery service begins operations in the area. Over time, with repeated visits, and repeated movements by the driver carrying a package to the door, or other common movement, the system may automatically adjust to update this delivery service vehicle as “familiar” where before it was classified as unfamiliar.

The process of automatically adjusting an object or activity from unfamiliar to familiar may be implemented by the system of the present disclosure for objects of any type including people, animals, and the like. For example, a new friend may be classified by the control logic 105 as an unfamiliar person, and later classified as a familiar person upon repeated visits. In another aspect, the control logic 105 may be configured to selectively only update a person, vehicle, animal, or other object, as familiar, based on input from a user. In some instances, it may be desirable to require user input classifying an object as familiar to avoid misclassification.

In another aspect, user input may be obtained via an input device of computing device 101. The user may be presented with visual and/or auditory output from camera 107 during playback, and may be given the option to change the classification for a detected object. The user may be given the option to specify whether the type or category that was determined by the rules in control logic 105 matches the image/sound output of the camera. For example, a rule in control logic 105 may be triggered based on image data indicating that a package has been delivered. Upon inspecting the image, the user 104 may determine that an object that is presently within the field-of-view of camera 106 is not a package but is instead some other type of object, and/or that the object is either familiar or unfamiliar to the user.

In another aspect, a remote service platform 102 may include one or more computers 103 with one or more processors configured to execute or implement aspects of the control logic 105. In this example, control logic 105 may be wholly, or partially, stored in, and maintained in, the service platform 102. The control logic as disclosed herein throughout, may be partially in the camera 107, partially in the remotes service platform 102, or any combination thereof. In one example, the disclosed AI algorithms may be maintained in the service platform 102 and may be configured to train AI models to implement the decision-making and classification aspects disclosed herein. These trained models or other aspects of the AI algorithms may be delivered to the camera 107 via a communication link 120.

In another aspect, the captured video data including multiple individual image frames may be sent from the camera 107 to the remote service platform 102 for processing according to the present disclosure. The service platform 102 may determine if events are taking place, whether an adjustment to the frame rate is in order, and the like, and it may send updated camera settings back to the camera 107. In this instance, the remote service platform 102 may operate to control the frame rates of multiple different cameras 107. In another aspect, the resulting dynamic time-lapse video may be optionally delivered from the service platform 102 to the computing device 101 via a communication link 121.

In another aspect, the camera 107 may include all control logic 105, and thus the dynamic time-lapse functionality of the present disclosure may be executed by the camera. The time-lapse output may be provided to the service platform 102 for storage. This sampled output received from the camera may optionally be delivered to the computing device 101 via the communication link 121.

In another aspect, the camera 107 and the service platform 102 may both include some portion of the control logic 105, and thus the dynamic time-lapse video logic of the present disclosure may be executed by the camera 107, the service platform 102, or any combination thereof. The output time-lapse video may be provided to the computing device 101 via an optional communication link 122 between the computing device 101 and the camera 107. In this example, the camera 107 may communicate directly with the computing device 101. Some of the input received from the camera 107 may optionally be passed to the service platform 102 by the computing device 101 if needed.

The user interface presented by computing device 101 may offer an option to indicate that an event type chosen by the control logic 105 is correct or is incorrect, and/or to adjust other configuration data or settings of the control logic. This input accepted by the system of the present disclosure may be obtained by the service platform 102 and passed along to the camera 107, or delivered from the computing device 101 directly to the camera 107. The service platform 102 may be configured to adjust one or more of the rule criteria threshold values accordingly to better match the video data to the desired event related determinations. These newly calculated values may be sent back to camera 107 and automatically installed in control logic 105 so that future determinations of event type, familiarity vs unfamiliarity, or other automatic determinations the system may make can be more accurate.

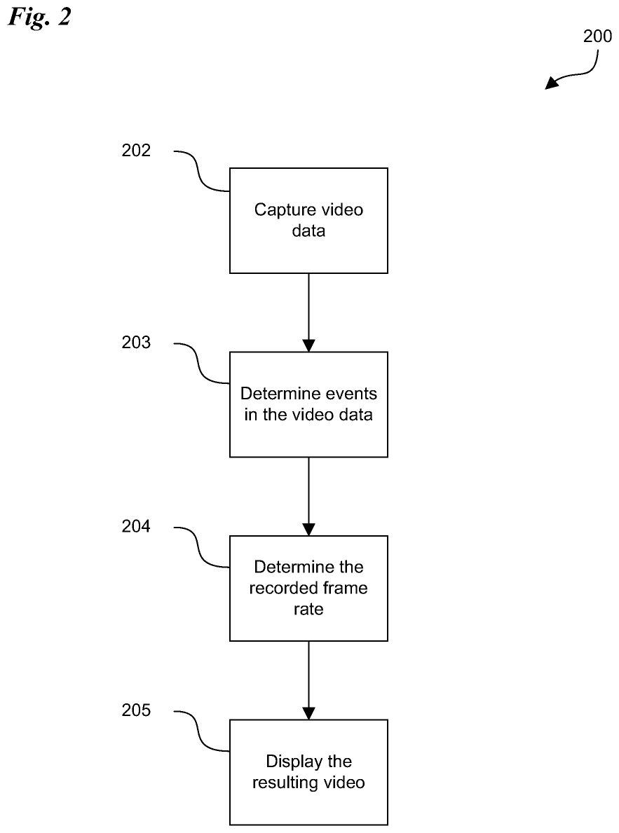

FIG. 2 is a flowchart illustrating aspects of the disclosed method for dynamic time-lapse recording of video data. The system of the present disclosure may be arranged and configured to capture video data at 202, and to detect events in the video data at 203. At 204, the frame rate of the recorded video is optionally determined according to the detected events at 203, and the resulting time-lapse video may be displayed at 205.

Capture the video at 202 optionally includes receiving, accepting, or capturing video data comprising multiple individual image frames, such as from a camera. In another aspect, the video may be obtained from a file, or multiple files, of a predetermined fixed length with a fixed number of individual frames saved in the file. In another example, the video may be obtained from a continuous stream of frames passing over a communication link such as in a streaming video feed obtained via a telecast, and the like. The multiple individual images may have been generated or captured and stored as video data that was captured at a predetermined and/or fixed number of frames per second.

In another aspect, video may be accepted from another camera system or other video provider for processing by the system of the present disclosure. A remote server or camera may send the captured video to a server or other computer of the present system for processing, and the resulting dynamic time-lapse video may be sent back after processing is complete. In another aspect, the video data with the multiple individual frames may be generated rather than captured by a camera, such as in the case of computer-generated video graphics or other Computer-Generated Imagery (CGI).

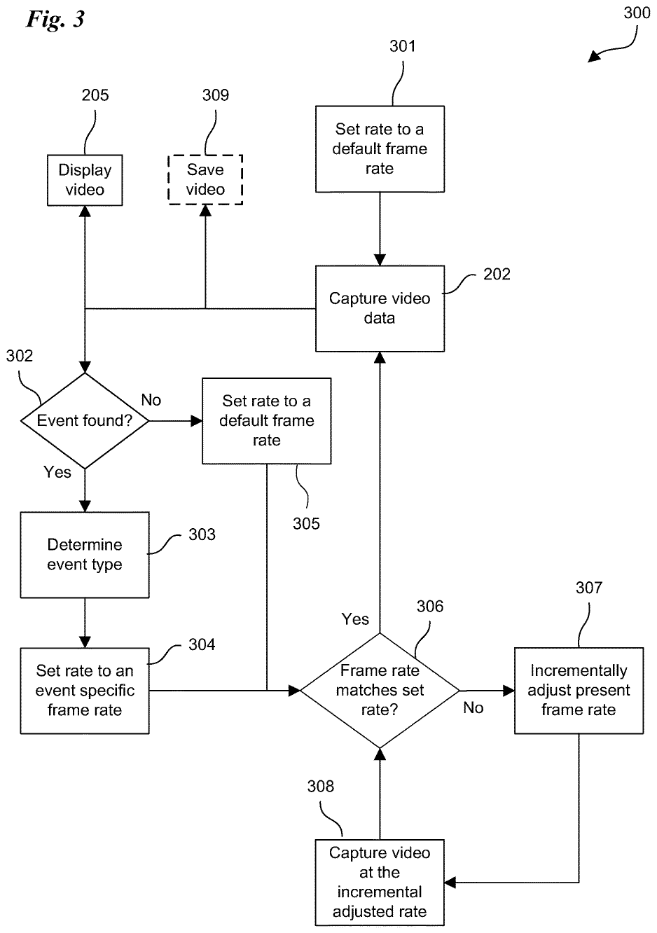

FIG. 3 illustrates at 300 another example of actions the system of the present disclosure may take in dynamically adjusting the time-lapse recording method of the present disclosure. The disclosed process optionally includes automatically adjusting the frame rate according to specific criteria such as the event type, familiarity of objects in the camera's field of view, etc. Differing portions of the video may thus be prepared for display according to the events found in the video frames, and this dynamic time laps processing may occur in real time as the video data is streamed, or later after the events have occurred by accessing a recording.

The system of the present disclosure may be arranged and configured to capture video data at 202, optionally at the default frame rate. The default frame rate may be set at 301 as a preliminary step. The system may determine if an event is found at 302, and the type of event is optionally determined according to the present disclosure at 303. In another aspect, the control logic may include object detection capabilities that may be implemented, for example, in an object detection module implemented in hardware and/or software. Object detection of the present disclosure optionally includes determining if a detected object is a person, pet, vehicle, or other category of object. This optionally includes accessing a database of familiar shapes and/or activities to determine if an event includes a familiar object. The database of information about familiar shapes may also include defining aspects of portions of shapes which may be used by the control logic to develop an overall assessment of what type of object is present. In another aspect, the control logic of the present disclosure may be arranged and configured to classify the type of event based on cues obtained from the video data. For example, an event classification module implemented in hardware and/or software may be included and may be used to classify each event with a specific event type.

In another aspect, the object detection module may be configured to determine differences between objects that are important and should be tracked versus objects that are unimportant. In one aspect, unimportant objects may be in the background of the image data while objects of greater importance may be more toward the foreground of an image. For example, objects moving further away may be of less interest relative to objects that are closer to the camera. In another aspect, objects that are always present may be ignored by the object detection module or classified with a low level of interest, as opposed to objects that are rarely present, or appear and disappear at unexpected times, or in differing locations in the camera's detection region. Conversely, objects that are always present, and generally of little interest, may also be of particular interest should they suddenly move, such as in the case of a shed, light pole, or other object being forced from its normal position by high winds in a storm.

In another aspect, some objects may be of a similar type or appearance, but may include features that differentiate them. For example, the object detection module may be configured to differentiate between a delivery truck of a well-known delivery service and its familiar driver that may be of less importance, and a moving truck of unknown origin with unfamiliar occupants which may have a similar shape, color, and orientation as the delivery truck, but be much more interesting for a variety of reasons. In another aspect, the object detection module may be configured to trigger an event when cars move around in the field-of-view, but not when trash cans, tables, chairs and the like are moved. These are a few nonexclusive examples of how the system of the present disclosure may automatically differentiate between foreground or background objects or events, or between objects or events that matter and those that do not matter.

In another aspect, the event detection according to the present disclosure may include accepting input specifying objects as familiar, unfamiliar, interesting, or uninteresting, and the like. In another aspect, event detection may include accepting input defining a new category for an object that the control logic of the present disclosure is unable to classify. In another aspect, the control logic of the present disclosure may be configured to automatically determine that an object is a familiar or unfamiliar object based on frequency of appearance of that object in the video data. This may include automatically modifying data about an object, or a type of object, to define that object as familiar after a predetermined number of appearances in the video feed. For example, the system may accept input defining a threshold value indicating that if the same object appears more than a threshold value number of times, the object should now be classified as familiar rather than unfamiliar. In another aspect, the system may generate a notification that a particular object, or type of object, has appeared numerous times and may need to be classified or marked as familiar. These aspects may be useful in training the control logic to better determine the types of objects and events that are of interest and differentiate them from those that are not of interest.

A specific frame rate may be set at 304 or the default frame rate at 305, optionally according to the type of event found. When an event is found in the video data at 302 according to the present disclosure, the system optionally sets an event specific frame rate at 304 based on criteria such as the type of event found (if any is found) at 303. The new sampling rate is optionally different for different types of events, and may be changed to a rate that is higher or lower than the previous frame rate, or optionally higher or lower than an optional default rate when an event is found.

The frame rate is optionally associated with a general or specific type of event found to be occurring at 304. In the present disclosure, the frame rate optionally defines the number of individual frames of video to retrieve from the video data per unit of recorded time. For example, a default frame rate for portions of the video data that do not include events of interest may be up to one frame from every tenth of a second of raw video, up to one frame per second of raw video data, up to one frame from every five seconds, up to one frame from every 20 seconds, or more. A lower frame rate results in reduced clarity and further reductions in playback time for the resulting video. In one instance, when the raw video data includes 30 frames per second of recorded video, then these example frame rates result in a reduction in the overall video data by a factor of 3, 30, 150, and 600 respectively.

The system optionally compares the frame rate set at 304, 305 with the present frame rate at 306. If they match, the video capture optionally continues at 202 at the set rate (also the present rate). In this instance, the frame rate is unchanged. When the set frame rate and the present frame rate do not match at 306, the present frame rate may be updated to match the set frame rate, and video capture optionally continues at the set rate at 202. In one instance, the frame rates change immediately, causing an abrupt difference in the apparent speed of the output video captured at 202. In another example, the frame rates may be ramped up (or down) progressively until the frame rate matches the set frame rate.

In another aspect, an incremental adjustment is optionally made to the present frame rate. This means the control logic may be configured to more gradually narrow the difference between the set rate and the present rate until the two match. Looking at FIG. 3, if the set rate and the present rate do not match at 306, an incremental adjustment may be made to the present rate at 307, and video is optionally captured at the incrementally adjusted frame rate at 308. Actions 306, 307, and 308 may repeat until the present rate matches the set rate at 306. The video capture then continues at the set rate at 202. Actions 306, 307, and 308 optionally adjust the frame rate more gradually with time from the present frame rate to the set frame rate. In another aspect, this gradual adjustment aspect may occur any time a new set rate is determined. Thus, the rate may gradually change at 306, 307, and 308 as new rates are set at 304 and 305 meaning both aspects of the disclosed method may occur continuously and/or simultaneously.

The incremental adjustment may be expressed in a number of frames per second such as +/−up to 1 frame per second, +/−up to 5 frames per second, +/−up to 30 frames per second, or more. In another aspect, the incremental adjustment may be expressed as a percentage of the present frame rate, such as +/−up to 1% of the present frame rate, +/−up to 5% of the present frame rate, +/−up to 30% of the present frame rate, or more. In another aspect, the increment may be a fixed increment, or the increment may also change as it is applied. For example, the first increment applied may be 1 FPS, the second 1 FPS, the third 2 FPS, the fourth 3 FPS, the fifth 5 FPS, the sixth 8 FPS, and so on until the present rate matches the set rate. Any suitable linear, geometric, exponential, logarithmic, or other progression may be used to gradually bring the present frame rate into line with the set frame rate.

In another aspect, the time between each adjustments may be a fixed time interval, a variable time interval, or a time interval that varies as the incremental adjustments are applied. For example, each increment may be applied with a time between increments of less than a tenth of a second, less than half a second, less than 1 second, or 2 seconds or more. As with the increment itself, any suitable linear, geometric, exponential, logarithmic, or other progression may be used to gradually change the time between which the increments are applied until the present frame rate into line with the set frame rate.

In another aspect, the incremental adjustment may be configured in the control logic of the present disclosure and may be adjusted, either automatically or by accepting input from a user. The incremental adjustment may be a configuration parameter shown in a user interface configured to display the parameter on a display device, and to accept input adjusting the incremental progression scheme used. In another aspect, the incremental adjustment, and other configuration parameters, may be stored in one or more individual cameras each with a differing, or separate adjustment

In another aspect, adding the sampled frames to output video data may include saving them to a memory, such as a buffer or output stream operable to store sampled video frames for later processing. In another aspect, separate buffers or output streams may be created and managed in a memory by the control logic of the present disclosure to maintain separate storage locations and/or data structures for video data associated with each type of event.

The captured frames may optionally be displayed at 205 on a display device, and optionally saved at 309. The sampled frames may be saved in volatile or nonvolatile memory storage such as on a local memory chip, in a hard drive, or on a remote data store via a computer network, or any combination thereof. If more video data is available to process, the actions repeat at 202. If no further video data is available, the process is optionally completed and processing ends.

The actions disclosed in FIG. 3 may be performed sequentially on multiple capture streams containing video data, either in parallel on many streams at the same time by multiple processors, execution threads, or other control logic. Some or all of the actions may thus occur simultaneously as multiple combinations of the disclosed action sequences are executed at the same time. Multiple different video feeds may be processed simultaneously, either by the individual cameras capturing the video, or by a centralized service platform handling raw input from multiple cameras and applying the disclosed method to create dynamic time-lapse output. In another aspect, the centralized service platform may retain the control logic of the present disclosure used by some or all of the cameras, including the incremental progression to use, as well as the logic for determining the presence of objects, type of object, familiarity of objects, and other aspects. In this instance, the cameras are responsive to the service platform and the service platform controls some or all of the behavior of the cameras.

### Clauses

The following numbered clauses set out examples of the disclosed concepts that may be useful in understanding the present disclosure:

Example 1: A method for dynamic time-lapse video recording using one or more processors.

Example 2: The method of any other example including automatically adjusting the time interval between recorded frames according to specific criteria.

Example 3: The method of any other example including automatically adjusting the frame rate according to specific criteria.

Example 4: The method of any other example including recording video data comprising multiple individual image frames.

Example 5 The method of any other example wherein the time between individual frames is determined as the video is recorded.

Example 6: The method of any other example including detecting events captured in the video data.

Example 7: The method of any other example including determining when an event starts and ends.

Example 8: The method of any other example including determining a category or type for the event when it starts.

Example 9: The method of any other example including displaying the frames at a predetermined frame rate.

Example 10: The method of any other example including capturing the frames of a video using a camera.

Example 11: The method of any other example wherein capturing video data includes capturing multiple individual images.

Example 12: The method of any other example wherein multiple individual images captured in the video data are captured at a varying number of images (“frames”) captured per unit of time.

Example 13: The method of any other example including determining the start of an event defined by one or more frames of a video.

Example 14: The method of any other example including determining the end of an event defined by one or more frames of a video.

Example 15: The method of any other example including using the one or more processors to analyze the video data to determine when an event has occurred.

Example 16: The method of any other example including using an event classification module implemented in hardware and/or software to classify an event type.

Example 17: The method of any other example including accessing a database of familiar shapes to determine if an invent includes a familiar object.

Example 18: The method of any other example including determining if a detected object is a person, pet, vehicle, or other category of object.

Example 19: The method of any other example including accepting input defining a new category of object.

Example 20: The method of any other example wherein data about familiar objects includes one or more images defining aspects of familiar shapes.

Example 21: The method of any other example including accepting input specifying familiar objects.

Example 22: The method of any other example including accepting input verifying that a portion of the video data includes familiar objects.

Example 23: The method of any other example including automatically determining that an object is a familiar or unfamiliar object based on frequency of appearance of that object in the video data.

Example 24: The method of any other example automatically modifying data about an object to define that object as familiar after a predetermined number of appearances in the video feed.

Example 25: The method of any other example wherein the system automatically modifies data about the object to define that object as familiar based on input received from a user interface.

Example 26: The method of any other example including accepting input defining an object as familiar.

Example 27: The method of any other example including determining that a movement event is the result of the camera being moved.

Example 28: The method of any other example including determining that a movement event is the result of an object passing through the field-of-view of a stationery camera.

Example 29: The method of any other example including differentiating movement of the camera from the movement of an object passing through the field-of-view of the camera.

Example 30: The method of any other example including using the control logic to adjust the frame rate from a present frame rate to a set frame rate.

Example 31: The method of any other example including using the control logic to adjust the frame rate from a present frame rate to a set frame rate when the set frame rate differs from the present frame rate.

Example 32: The method of any other example including gradually adjust the frame rate from a present frame rate to a set frame rate over time.

Example 33: The method of any other example wherein each incremental adjustment to the frame rate is a fixed number of frames per second.

Example 34: The method of any other example wherein each incremental adjustment to the frame rate is a variable number of frames per second.

Example 35: The method of any other example wherein each incremental adjustment to the frame rate is a percentage of the difference between the present rate and the set rate.

Example 36: The method of any other example wherein each incremental adjustment to the frame rate is determined by an exponential, logarithmic, geometric, or other number progression.

Example 37: The method of any other example wherein the control logic is configured to determine the event type is in the camera.

Example 38: The method of any other example wherein the control logic for determining an event has occurred includes artificial intelligence.

Example 39: The method of any other example wherein the control logic for determining the type of event that has occurred includes artificial intelligence.

Example 40: The method of any other example including preparing portions of the video for display according to the events found in the video data.

Example 41: The method of any other example including accessing one or more individual frames of video from the video data.

Example 42: The method of any other example including determining the number of individual frames of video to retrieve from the video data.

Example 43: The method of any other example including determining a frame rate defining the number of individual frames of video to retrieve from the video data per unit of recorded time.

Example 44: The method of any other example including obtaining frames from the recorded video data at a default frame rate.

Example 45: The method of any other example including changing the frame rate for the camera recording the video data.

Example 46: The method of any other example wherein the frame rate is increased when an event is found.

Example 47: The method of any other example including determining a new frame rate based on the category of event found.

Example 48: The method of any other example wherein the new frame rate is different for different types of events.

Example 49: The method of any other example including changing the frame rate to a person event rate when a person is detected in the video data.

Example 50: The method of any other example including changing the frame rate to an unfamiliar person frame rate when an unfamiliar person or object is detected in the video data.

Example 51: The method of any other example including changing the frame rate to a pet frame rate when a pet is detected in the video data.

Example 52: The method of any other example including changing the frame rate to a movement frame rate when movement is detected in the video data.

Example 53: The method of any other example including displaying the frames obtained from the video data for each individual sampled portion of the video.

Example 54: The method of any other example including displaying the sampled portions of the video in succession.

Example 55: The method of any other example including displaying the sampled portions of the video at a predetermined fixed frame rate.

Example 56: The method of any other example including accepting input selecting a sampled portion of the video to display.

Example 57: The method of any other example including displaying the original unsampled video for an individual sampled portion of the video.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“Alert” generally refers to an audible and/or visual message intended to inform a system's users or administrators about a change in the operating conditions of the system or about an error condition of the system. In a graphical user interface, the alert may be displayed as a small window containing a message and/or photo detailing the alert information and parameters. In some examples, the alert may include a button (virtual or physical) to click in order to dismiss the alert. In other examples, the alert may be strictly audible and based on preset parameters. In a further example, the alert may be transmitted to a remote device for analysis. Other synonymous terms for alert include alarm and/or notification.

“And/or” is inclusive here, meaning “and” as well as “or”. For example, “P and/or Q” encompasses, P, Q, and P with Q; and, such “P and/or Q” may include other elements as well.

“Artificial Intelligence” generally refers to using a computer algorithm, or set of instructions, to simulate human intelligence processes by computer systems. Specific applications of AI include expert systems, natural language processing, speech recognition and machine vision.

“Camera” generally refers to an apparatus or assembly that records images of a viewing area or field-of-view on a medium or in a memory. The images may be still images comprising a single frame or snapshot of the viewing area, or a series of frames recorded over a period of time that may be displayed in sequence to create the appearance of a moving image. Any suitable media may be used to store, reproduce, record, or otherwise maintain the images.

“Communication Link” generally refers to a connection between two or more communicating entities and may or may not include a communications channel between the communicating entities. The communication between the communicating entities may occur by any suitable means. For example the connection may be implemented as an actual physical link, an electrical link, an electromagnetic link, a logical link, or any other suitable linkage facilitating communication.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Control Logic” generally refers to hardware or software configured to implement an automatic decision making process by which inputs are considered, and corresponding outputs are generated. The output may be used for any suitable purpose such as to provide specific commands to machines or processes specifying specific actions to take. Examples of control logic include computer programs executed by a processor to accept commands from a user and generate output according to the logic implemented in the program as executed by the processor. In another example, control logic may be implemented as a series of logic gates, microcontrollers, and the like, electrically connected together in a predetermined arrangement so as to accept input from other circuits or computers and produce an output according to the rules implemented in the logic circuits.

“Controller” or “control circuit” generally refers to a mechanical or electronic device configured to control the behavior of another mechanical or electronic device. A controller or “control circuit” is optionally configured to provide signals or other electrical impulses that may be received and interpreted by the controlled device to indicate how it should behave.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data). The DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, chained model (such as in the case of a “blockchain” database), the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group; Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, California, USA; the DBMS generally referred to as “SAP” provided by SAP SE of Walldorf, Germany; and the D22 DBMS provided by the International Business Machines Corporation (IBM) of Armonk, New York, USA.

The database and the DBMS software may also be referred to collectively as a “database”. Similarly, the term “database” may also collectively refer to the database, the corresponding DBMS software, and a physical computer or collection of computers. Thus the term “database” may refer to the data, software for managing the data, and/or a physical computer that includes some or all of the data and/or the software for managing the data.

“Detection Zone” generally refers to an area within which an object may be detected. The detection zone may be either two dimensional and or three dimensional and may be defined by one or more sensors operable to detect objects within the detection zone, or by a control circuit that is responsive to the sensors.

“Display device” generally refers to any device capable of being controlled by an electronic circuit or processor to display information in a visual or tactile. A display device may be configured as an input device taking input from a user or other system (e.g. a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, yellow, and green indicators configured to indicate a temperature range.

“Input Device” generally refers to any device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Frame Rate” generally refers (commonly expressed in “frames per second” or FPS) is typically the frequency (rate) at which consecutive images (frames) are captured or displayed. This is generally applicable to film and video cameras, computer animation, and motion capture systems.

In these contexts, frame rate may be used interchangeably with frame frequency and refresh rate, which are expressed in hertz. Additionally, in the context of computer graphics performance, FPS is the rate at which a system, particularly a Graphics Processing Unit (GPU), is able to generate frames, and refresh rate is the frequency at which a display shows completed frames.

In electronic camera specifications frame rate refers to the maximum possible rate frames can be captured, but in practice, other settings (such as exposure time) may reduce the actual frequency to a lower number than the frame rate.

“Means For” in a claim invokes 35 U.S.C. 112(f), literally encompassing the recited function and corresponding structure and equivalents thereto. Its absence does not, unless there otherwise is insufficient structure recited for that claim element. Nothing herein or elsewhere restricts the doctrine of equivalents available to the patentee.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPv6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Neural Network” generally refers to a collection of cooperating computational nodes implemented in hardware and/or software that use a mathematical or computational model for information processing based on a connectionistic approach to computation. A neural network may be an adaptive system that changes its structure based on external or internal information that flows through the network. The connections between nodes may be “weighted” to achieve specific outcomes given a wide range of inputs. A more positive weight reflects a more relevant or more “excitatory” connection, while a more negative weight reflects a more uninteresting or more “inhibitory” connections. All inputs to each node are modified according to the weights and summed. This activity is referred to as a linear combination. Finally, an activation function is generally used by each node to control the amplitude of the output. For example, an acceptable range of output is usually between 0 and 1, or it could be −1 and 1. The output of each node may then be fed as input to other nodes, and thus the overall network of nodes may be able to solve complex problems and/or to adapt to changes in the input over time.

These artificial networks may be used for predictive modeling, adaptive control and applications where they can be trained via a dataset. Self-learning resulting from experience can occur within networks, which can derive conclusions from a complex and seemingly unrelated set of information.

“Optionally” as used herein means discretionary; not required; possible, but not compulsory; left to personal choice.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Personal computing device” generally refers to a computing device configured for use by individual people. Examples include mobile devices such as Personal Digital Assistants (PDAs), tablet computers, wearable computers installed in items worn on the human body such as in eye glasses, watches, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.

“Portion” means a part of a whole, either separated from or integrated with it.

“Predominately” as used herein is synonymous with greater than 50%.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if(clouds.areGrey( ) and
(clouds.numberOfClouds > 100)) then
{
  prepare for rain;
} else {
  Prepare for sunshine;
}
```

“Sampling Rate” generally refers to a number of samples taken per second. This is common in multiple areas of interest such as in converting analog wave (a continuously changing value or collection of values) to digital input (a discrete wave). Two equivalent units for sampling rate are samples per second (sps) or Hertz (Hz).

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Transformer” generally refers to a deep learning architecture that implements a parallel multi-head attention mechanism. Transformers may be applied to text or classify image input.

Transformers generally include an initial step by which the input is apportioned or broken up into manageable pieces. For text, tokenizers may be applied to convert text into tokens. In the case of image or video input, image processing may be applied to convert an image to a collection or sequence of flattened image patches.

The transformer architecture optionally also includes a single embedding layer, which converts the portions and positions of the portions into vector representations, one or more transformer layers, which carry out repeated transformations on the vector representations, extracting more and more image context or linguistic information (and these generally consist of alternating attention and feedforward layers), and optionally, an unembedding layer, which converts the final vector representations back to a probability distribution over the different portions.

Text may be split into n-grams encoded as tokens and each token converted into a vector via a table lookup. At each layer, each token is then contextualized within the scope of the context window with other (unmasked) tokens via a parallel multi-head attention mechanism allowing the signal for key tokens to be amplified and less important tokens to be diminished.

the final vector representations back to a probability distribution over the tokens.

“Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.

“User Interface” generally refers an aspect of a device or computer program that provides a means by which the user and a device or computer program interact, in particular by coordinating the use of input devices and software. A user interface may be said to be “graphical” in nature in that the device or software executing on the computer may present images, text, graphics, and the like using a display device to present output meaningful to the user, and accept input from the user in conjunction with the graphical display of the output.

“Viewing Area”, “Field of View”, or “Field of Vision” is the extent of the observable world that is seen at any given moment. In case of optical instruments, cameras, or sensors, it is a solid angle through which a detector is sensitive to electromagnetic radiation that include light visible to the human eye, and any other form of electromagnetic radiation that may be invisible to humans.

“Wi-Fi” generally refers to a family of wireless network protocols that are based on the IEEE 802.11 family of standards. Wi-Fi networks are commonly used for local area networking of devices so that these devices may communicate with each other and with a broader computer network such as the Internet. Wi-Fi protocols define how enabled devices may exchange data wirelessly via radio waves. Wi-Fi wireless connections may be useful for providing wireless communications links between desktop and laptop computers, cameras, tablet computers, smartphones, smart TVs, printers, smart speakers, and the like with wireless network access devices to connect them to the Internet.

Wi-Fi uses multiple parts of the IEEE 802 protocol family and is designed to be operable seamlessly with wired communication protocols, such as Ethernet. Compatible devices can network through wireless access points to each other as well as to wired devices and the Internet. The different versions of Wi-Fi are specified by various IEEE 802.11 protocol standards, with different radio technologies determining radio bands, and the maximum ranges, and data rates that may be achieved. For example, Wi-Fi uses the 2.4 gigahertz (120 mm wavelength) UHF and 5 gigahertz (60 mm wavelength) SHF radio bands, which may be subdivided into multiple channels.

The radio frequencies typically used by Wi-Fi transmitters and receivers have relatively high absorption rates and work best for line-of-sight communication links. Many common obstructions such as walls, pillars, home appliances, etc. may greatly reduce range, but interference between different networks in crowded environments is usually minimal. In one example, a Wi-Fi network access point may have a range of about 65 feet indoors, or as much as 500 feet outdoors. Wireless network access points may include a single transmitter/receiver to cover a single room to a multiple transmitters/receivers spread over square miles of area to provide overlapping access to client devices.

What is claimed is:

1. A method, comprising:
automatically detecting events captured in video data according to specific criteria using one or more processors of one or more computers;
determining a time interval between two or more recorded frames of video data;
recording the video data at the determined time interval, wherein the time interval between the two or more recorded frames is adjusted as the video data is captured; and
displaying the frames at a predetermined frame rate.

2. The claim 1, comprising:
determining a category or type for the event when it starts.

3. The claim 1, comprising:
capturing the frames of a video using a camera.

4. The method of claim 1, wherein capturing video data includes capturing multiple individual images.

5. The method of claim 1, wherein multiple individual images captured in the video data are captured at a varying number of images captured per unit of time.

6. The method of claim 1, comprising:
using the one or more processors to analyze the video data to determine when an event has occurred.

7. The method of claim 1, comprising:
determining a start of an event defined by one or more frames of a video.

8. The method of claim 1, comprising:
determining an end of an event defined by one or more frames of a video.

9. The method of claim 1, comprising:
using an event classification module implemented in hardware and/or software to classify an event type.

10. The method of claim 1, comprising:
accessing a database of familiar shapes to determine if an invent includes a familiar object.

11. The method of claim 1, comprising:
determining if a detected object is a person, pet, vehicle, or other category of object.

12. The method of claim 1, comprising:
automatically determining that an object is a familiar or unfamiliar object based on frequency of appearance of that object in the video data.

13. The method of claim 1, comprising:
automatically modifying data about an object to define that object as familiar after a predetermined number of appearances in the video feed.

14. The method of claim 1, comprising:
automatically modifying data about an object to define that object as familiar based on input received from a user interface.

15. The method of claim 1, comprising:
determining that a movement event has occurred, and that it is a result of movement of a camera capturing the video data.

16. The method of claim 1, comprising:
determining that a movement event has occurred, and that it is a result of an object passing through a field-of-view defined by a stationary camera.

17. The method of claim 1, comprising:
using control logic executed by the one or more processors to adjust the frame rate from a present frame rate to a set frame rate when the set frame rate differs from the present frame rate.

18. The method of claim 1, comprising:
automatically adjusting the frame rate from a present frame rate to a set frame rate in incremental adjustments made over time.

19. The method of claim 18, wherein each incremental adjustment to the frame rate is a fixed number of frames per second.

20. The method of claim 18, wherein each incremental adjustment to the frame rate is a variable number of frames per second.

21. The method of claim 18, wherein each incremental adjustment to the frame rate is a percentage of a difference between a present rate and a set rate.

22. The method of claim 1, wherein control logic that is configured to determine the event type is in a camera that is capturing the video data.

23. The method of claim 1, comprising:
preparing portions of the video for display according to the events found in the video data.

24. The method of claim 1, comprising:
obtaining frames from the recorded video data at a default frame rate, and wherein the frame rate is increased when an event is found.

25. The method of claim 24, comprising:
determining a new frame rate based on a category of event found.
